(19) United States
(12) Patent Application Publication
(10) Pub. No.: US 2016/0145919 A1
(43) Pub. Date: May 26, 2016

(54) HINGE SYSTEM HAVING COMBINED COMPLIANT HINGES

(71) Applicant: BRIGHAM YOUNG UNIVERSITY, Provo, UT (US)

(72) Inventors: Larry L. HOWELL, Orem, UT (US); Spencer P. MAGLEBY, Provo, UT (US); Jessica MORGAN, Provo, UT (US); Todd NELSON, Provo, UT (US); Nathan PEHRSON, Provo, UT (US); Eric WILCOX, San Diego, CA (US)

(21) Appl. No.: 14/952,362

(22) Filed: Nov. 25, 2015

Related U.S. Application Data
(60) Provisional application No. 62/123,787, filed on Nov. 26, 2014.

(51) Int. Cl. E05D 1/06

(52) U.S. Cl. CPC E05D 1/06

(57) ABSTRACT

According to an aspect, a hinge system includes a first compliant hinge having a first attachment portion, a first flexible portion, and a first movable portion, where the first flexible portion is disposed between the first attachment portion and the first movable portion, and a second compliant hinge having a second attachment portion, a second flexible portion, and a second movable portion, where the second flexible portion is disposed between the second attachment portion and the second movable portion. The first attachment portion is coupled to the second attachment portion. The hinge system is configured to move from an un-deflected configuration to a deflected configuration in which the first movable portion and the second movable portion move away from each other.

### CROSS-REFERENCE TO RELATED APPLICATION

This application is a Non-provisional of, and claims priority to, U.S. Patent Application No. 62/123,787, filed on Nov. 26, 2014, entitled “Acutely Combined Torsional Hinge”, which is incorporated by reference herein in its entirety.

### TECHNICAL FIELD

This disclosure relates generally to a hinge system having a first compliant hinge coupled to a second compliant hinge, and devices having one or more of the hinge systems.

### BACKGROUND

Compliant hinges are used within a wide variety of applications in order to create a hinge-type motion. Typically, a conventional compliant hinge has one layer of material with a flexible segment. In some applications, the use of conventional compliant hinges may make the device relatively more difficult to deploy and stow.

### SUMMARY

According to an aspect, a hinge system includes a first compliant hinge having a first attachment portion, a first flexible portion, and a first movable portion, where the first flexible portion is disposed between the first attachment portion and the first movable portion, and a second compliant hinge having a second attachment portion, a second flexible portion, and a second movable portion, where the second flexible portion is disposed between the second attachment portion and the second movable portion. The first attachment portion is coupled to the second attachment portion. The hinge system is configured to move from an un-deflected configuration to a deflected configuration in which the first movable portion and the second movable portion move away from each other.

The hinge system may include one or more of the following features (or any combination thereof). In the un-deflected configuration, the first flexible portion and the second flexible portion may be disposed in a linear configuration. In the un-deflected configuration, the first attachment portion may be coupled to the second attachment portion such that the first compliant hinge is disposed in parallel with the second compliant hinge. In the un-deflected configuration, the first attachment portion may be coupled to the second attachment portion such that the first compliant hinge is disposed at a non-zero angle with the second compliant hinge. The non-zero angle may be an acute angle. The first attachment portion may be integral to the second attachment portion. In the deflected configuration, the first flexible portion may bend such that a longitudinal axis of the first movable portion forms a first angle of deflection with a central axis of the hinge system, and the second flexible may bend such that a longitudinal axis of the second movable portion forms a second angle of deflection with the central axis. The first angle of deflection may be the same as the second angle of deflection. The first angle of deflection and the second angle of deflection may be acute angles. The first flexible portion may define slots.

According to an aspect, a hinge system includes a first compliant hinge having a first attachment portion, a first flexible portion, and a first movable portion, wherein the first flexible portion is disposed between the first attachment portion and the first movable portion, and a second compliant hinge having a second attachment portion, a second flexible portion, and a second movable portion, where the second flexible portion is disposed between the second attachment portion and the second movable portion. The first attachment portion is coupled to the second attachment portion. The hinge system is configured to move from an un-deflected configuration to a deflected configuration such that the first movable portion and the second movable portion move away from each other. In the deflected configuration, the first flexible portion may bend such that the first movable portion and the first attachment portion forms a first angle of deflection, and the second flexible portion may bend such that the second movable portion and the second attachment portion forms a second angle of deflection. The movement from the un-deflected configuration to the deflected configuration may define a sweep angle of the hinge system, and the sweep angle is defined by a combination of the first angle of deflection and the second angle of deflection.

The hinge system may include any of the above or below features (or any combination thereof). In the un-deflected configuration, the first flexible portion and the second flexible portion may be in a linear configuration. In the un-deflected configuration, the first attachment portion may be coupled to the second attachment portion such that the first compliant hinge is disposed in parallel with the second compliant hinge. In the un-deflected configuration, the first attachment portion may be coupled to the second attachment portion such that the first compliant hinge is disposed at a non-zero angle with the second compliant hinge. The non-zero angle may be an acute angle. The first attachment portion may be integral to the second attachment portion. The first angle of deflection may be the same as the second angle of deflection. The first angle of deflection and the second angle of deflection are acute angles. Each of the first flexible portion and the second flexible portion may define slots.

According to an aspect, a device may include a first hinge system including a first compliant hinge having a first attachment portion, a first flexible portion, and a first movable portion, and a second compliant hinge having a second attachment portion, a second flexible portion, and a second movable portion. The first attachment portion is coupled to the second attachment portion. The first hinge system is configured to move from an un-deflected configuration to a deflected configuration in which the first movable portion and the second movable portion move away from each other. The device also includes a second hinge system.

According to an aspect, a hinge system may include a compliant hinge having an attachment portion, a flexible portion, and a movable portion, where the flexible portion is disposed between the attachment portion and the movable portion, and an elongate member having a first end portion and a second end portion. The attachment portion of the compliant hinge is coupled to the first end portion of the elongate member. The hinge system is configured to move from an un-deflected configuration to a deflected configuration in which the movable portion of the complaint hinge and the second end portion of the elongate member move away from each other.

### BRIEF DESCRIPTION OF THE DRAWINGS

FIG. 1A illustrates a side view of a hinge system in a deflected configuration according to an aspect.

FIG. 1B illustrates a side view of the hinge system in an un-deflected configuration according to an aspect.

FIG. 2A illustrates a perspective of the hinge system in the deflected configuration according to an aspect.

FIG. 2B illustrates a perspective of the hinge system in the un-deflected configuration according to an aspect.

FIG. 3 illustrates a side view schematic of the hinge system according to an aspect.

FIG. 4A illustrates a side view of a hinge system in a deflected configuration according to an aspect.

FIG. 4B illustrates a side view of the hinge system in an un-deflected configuration according to an aspect.

FIG. 5A illustrates a perspective of the hinge system in the deflected configuration according to an aspect.

FIG. 5B illustrates a perspective of the hinge system in the un-deflected configuration according to an aspect.

FIG. 6 illustrates a side view schematic of the hinge system according to an aspect.

FIG. 7 illustrates an example of a complaint hinge with a thermal expansion relief cut according to an aspect.

FIG. 8A illustrates a deployed camping stove assembly with panels connected by two hinge systems according to an aspect.

FIG. 8B illustrates a stowed camping stove assembly folded upon itself according to an aspect.

FIG. 8C illustrates a perspective of the camping stove assembly according to an aspect.

FIG. 8D illustrates another perspective of the camping stove assembly according to an aspect.

### DETAILED DESCRIPTION

The implementations discussed herein provide a hinge system that joins two compliant hinges in a manner that can achieve increased overall sweep angle while maintaining relatively low stresses in the compliant hinges. Each of the combined complaint hinges includes a flexible portion between two relatively rigid end portions, where the flexible portion enables hinge-type motion. An end portion of one compliant hinge is coupled to an end portion of another compliant hinge, where the other end portions of the compliant hinges can move or rotate away and toward each other. One compliant hinge may provide a sweep motion from its longitudinal axis to a first angle of deflection, and the other compliant hinge may provide a sweep motion from its longitudinal axis to a second angle of deflection. The compliant hinges are coupled together in a manner that combines the sweep motion from both compliant hinges, which provides a sweep angle greater that what is provided by a single compliant hinge. The increased sweep angle provided by the hinge system may reduce the length of the hinge system. Also, the hinge-type motion provided by the hinge system may reduce or eliminate friction, wear, or the need for lubrication. Furthermore, the design of the hinge system may reduce the number of hinge components used in certain applications. Furthermore, in some examples, the hinge system may move to a configuration in which the combined compliant hinges lie flat on top of each other, thereby allowing the device to be more compact. In other examples, the hinge system includes a compliant hinge and an elongate member (e.g., the elongate member is not a compliant), where the elongate member includes a first end portion and a second end portion. The first end portion of the elongate member is coupled to an end portion of the compliant hinge such that the compliant hinge is configured to move from an un-deflected configuration to a deflection configuration in which the first end portion of the elongate member and the other end of the compliant hinge (e.g., the portion that is not attached to the elongate member) move away from each other.

The hinge system or multiple hinge systems may be used within a wide variety of devices. For example, one or more of the hinge systems described herein may be incorporated into hinge/bearing/bushing-spring system replacement for applications to provide off-axis flexibility in order to accommodate misalignment or damage, hinge/bearing/bushing-spring system replacement for applications in harsh environments affected by temperature gradients, particulates (e.g., sand, dust, or other contaminates that could affect traditional bearings or hinges), vacuums (e.g., where outgassing of lubricants and friction welding can be an issue), slip-ring and hinge/bearing/bushing-spring system replacement (e.g., it can conduct electricity across the hinge without a slip-ring when rotation is within the range of motion), foldable camping gear (e.g., foldable cook stove), deployable systems (e.g., portable shields, targets), compact furniture (e.g., furniture that is deployed rather than assembled), deployable shelters (e.g., emergency shelters that are compact for storage and transport and are deployed on site without assembly), packaging (e.g., monolithic packaging with built-in hinge in materials other than paper or plastic), collapsing signs (e.g., highway signs that collapse on impact but snap back after the load is removed), covers and cases (e.g., tablet covers and violin cases), and exoskeleton hinges. However, the hinge systems discussed herein may be incorporated into other types of applications.

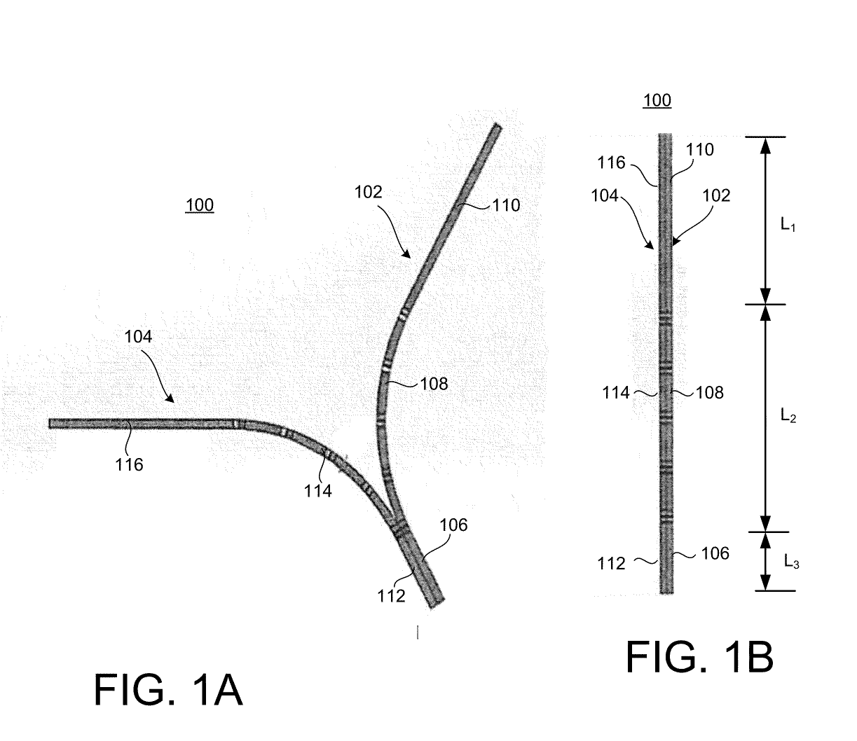

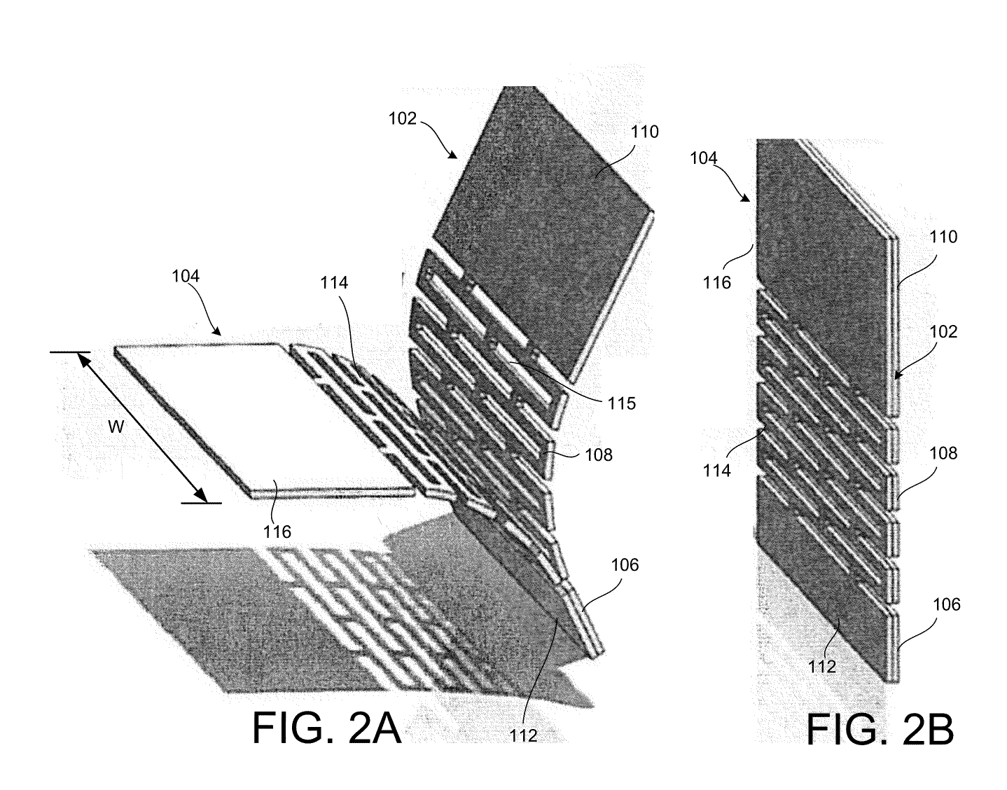

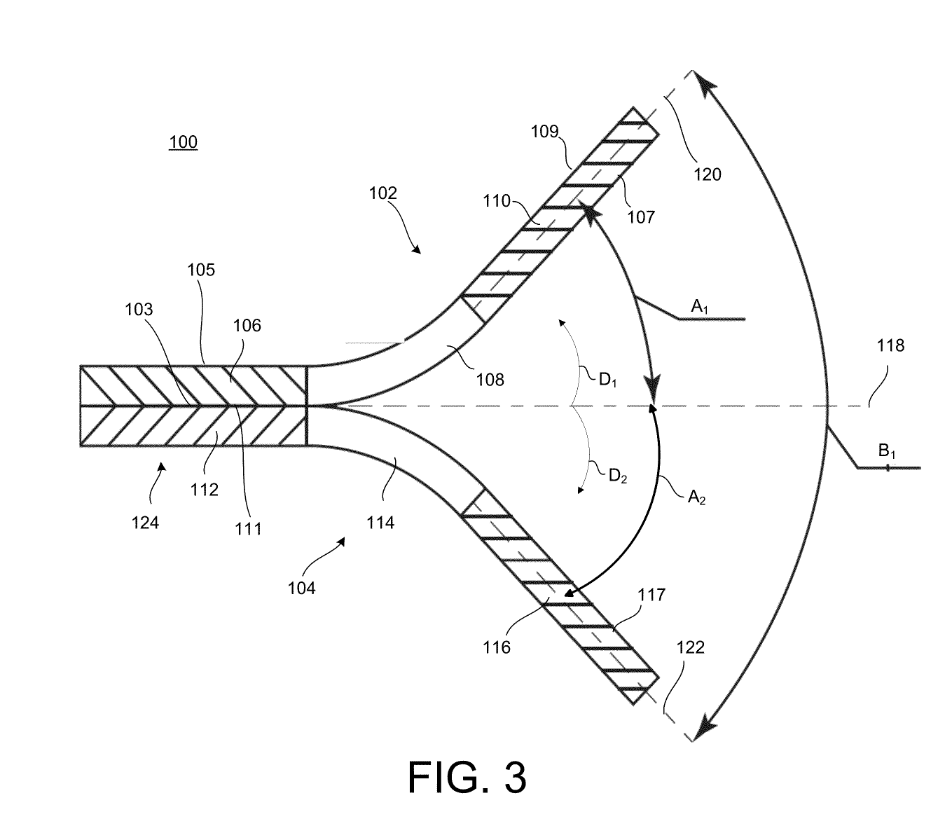

FIG. 1A illustrates a side view of a hinge system 100 in a deflected configuration according to an aspect. FIG. 1B illustrates a side view of the hinge system 100 in an un-deflected configuration according to an aspect. FIG. 2A illustrates a perspective of the hinge system 100 in the deflected configuration according to an aspect. FIG. 2B illustrates a perspective of the hinge system 100 in the un-deflected configuration according to an aspect. FIG. 3 illustrates a side view schematic of the hinge system 100 according to an aspect.

Referring to FIGS. 1-3, the hinge system 100 may include a first compliant hinge 102 and a second compliant hinge 104. The first compliant hinge 102 may include a first attachment portion 106, a first flexible portion 108, and a first movable portion 110. The second compliant hinge 104 may include a second attachment portion 112, a second flexible portion 114, and a second movable portion 116. In other examples, the second compliant hinge 104 is not a hinge, but rather an elongate member (e.g., a rigid panel). The elongate member may be a separate layer of material that does not function as a hinge. In some examples, the elongate member is a relatively rigid piece of material. In some examples, the elongate member may include one or more of the same features as described with reference to the second compliant hinge 104 except that the elongate member does not include the flexible portion 114. In this example, the elongate member may include a first end portion and a second end portion, where the first end portion of the elongate member is coupled to the first attachment portion 106 of the first compliant hinge 104 in the manner as described below with reference to figures such that the second end portion of the elongate member and the first movable portion 110 of the first compliant hinge 102 may move away from each other.

Referring to FIG. 3, the first compliant hinge 102 may be coupled to the second compliant hinge 104 in a manner that combines each compliant hinge's angle of deflection (A₁, A₂), thereby providing a greater sweep angle (B₁) than what can be provided by a single compliant hinge having the same length. Referring to FIGS. 1B and 3, the hinge system 100 may reduce its total longitudinal length (e.g., L₁+L₂+L₃) by half when compared to a conventional compliant hinge rotating through the same sweep angle B₁.

Referring to FIGS. 1-3, the first attachment portion 106 of the first compliant hinge 102 may be fixedly coupled to the second attachment portion 112 of the second compliant hinge 104. The hinge system 100 may move from the un-deflected configuration in which the first movable portion 110 is adjacent to the second movable portion 116 such that the hinge system 100 forms a linear configuration (see FIGS. 1B, 2B) to a deflected state in which the first movable portion 110 and the second movable portion 116 rotate away from each other (see FIGS. 1A, 2B, 3).

The structure of the first compliant hinge 102 may be equivalent to the structure of the second compliant hinge 104. For example, the first compliant hinge 102 may have a shape, length, width, and/or thickness that is the same as the second compliant hinge 104. In other examples, the shape, length, width, and/or thickness of the second compliant hinge 104 may be different than the first compliant hinge 102.

The first compliant hinge 102 and the second compliant hinge 104 may include living hinges, or torsional hinges. Generally, the first compliant hinge 102 may be a layer of material having a flexible section (e.g., the first flexible portion 108) disposed between two end portions (e.g., the first attachment portion 106, the first movable portion 110) and the second compliant hinge 104 may be another layer of material having a flexible section (e.g., the second flexible portion 114) disposed between two end portions (e.g., the second attachment portion 112, the second movable portion 116). In some examples, the first compliant hinge 102 may be constructed of a first material, and the second compliant hinge 104 may be constructed of a second material. In some examples, the first material may be the same as the second material. In other examples, the first material may be different than the second material. In some examples, the first material and/or the second material may be a polymer-based material. In some examples, the first material and/or the second material may be a metal-based material. In some examples, the first material and/or the second material may be a combination of the polymer-based material and the metal-based material.

Referring to the first compliant hinge 102, the first flexible portion 108 may be disposed between the first attachment portion 106 and the first movable portion 110. The first attachment portion 106 and the first movable portion 110 may be relatively rigid sections of the first compliant hinge 102. For example, the first attachment portion 106 and the first movable portion 110 may be more rigid than the first flexible portion 108. The first attachment portion 106 may have the same rigidity as the first movable portion 110. In other examples, the first attachment portion 106 is more or less rigid than the first movable portion 110.

The first flexible portion 108 may be configured to bend such that the first movable portion 110 may move or rotate relative to the first attachment portion 106. In some examples, the first flexible portion 108 may be made from the same material as the first attachment portion 106 and the first movable portion 110, but has one or more features that render the first flexible portion 108 more flexible than the first attachment portion 106 and the first movable portion 110. In some examples, the thickness of the first flexible portion 108 may be smaller than the thickness of the first attachment portion 106 and the first movable portion 110, thereby rendering the first flexible portion 108 more flexible than the first attachment portion 106 and the first movable portion 110. In some examples, as shown in FIG. 1B, the first flexible portion 108 may have slots 115 that allow the first flexible portion 108 to bend. For example, various portions of the first flexible portion 108 may be removed to create the slots 115. In some examples, the cut-out portions extend entirely through the thickness of the first flexible portion 108, thereby creating the slots 115. In other examples, the cut-out portions do not extend entirely through the thickness of the first flexible portion 108. In some examples, the slots 115 are rectangular. In other examples, the slots 115 may have one or more portions that are non-rectangular. In some examples, at least some adjacent slots of the slots 115 are offset from each other. In some examples, the slots 115 are orientated perpendicular to the direction of the bend. In other examples, one or more of the slots 115 are disposed at angle with respect to the direction of the bend. In some examples, the slots 115 on the first flexible portion 108 are arranged in a pattern that is the same as the pattern on the second flexible portion 114. In other examples, the slots 115 on the first flexible portion 108 are arranged in a pattern that is different than the pattern on the second flexible portion 114.

The first attachment portion 106, the first flexible portion 108, and the first movable portion 110 may be integrally formed. For example, the first attachment portion 106, the first flexible portion 108, and the first movable portion 110 may be different sections of the same layer of material, where the first flexible portion 108 is modified to make it bendable (e.g., removing various portions to create the slots 115). In other examples, the first attachment portion 106, the first flexible portion 108, and/or the first movable portion 110 are separate components that are coupled together. In some examples, the first attachment portion 106, the first flexible portion 108, and the first movable portion 110 include different materials, where the material of the first flexible portion 108 is more flexible than the materials of the first attachment portion 106 and the first movable portion 110. In some examples, the first flexible portion 108 includes a material different than the first attachment portion 106 and the first movable portion 110, but the first attachment portion 106 and the first movable portion 110 include the same material.

The length of the first movable portion 110 may be longer than the length of the first attachment portion 106. In some examples, the length of the first movable portion 110 is shorter than the length of the first attachment portion 106. In some examples, the length of the first movable portion 110 is the same as the length of the first attachment portion 106. The length of the first flexible portion 108 may be shorter than both of the length of the first attachment portion 106 and the first movable portion 110. In other examples, the length of the first flexible portion 108 is longer than the length of the first attachment portion 106 and/or the first movable portion 110.

Referring to FIG. 3, the first attachment portion 106 may include a first surface 103 and a second surface 105 opposite to the first surface 103. In some examples, the first surface 103 of the first attachment portion 106 and/or the second surface 105 of the first attachment portion 106 may be planar or substantially flat. In other examples, the first surface 103 of the first attachment portion 106 and/or the second surface 105 of the first attachment portion 106 may include one or more curved portions or protrusions. In some examples, the first attachment portion 106 is a rectangular panel. The first movable portion 110 may include a first surface 107 and a second surface 109 opposite to the first surface 107. The first surface 107 of the first movable portion 110 and/or the second surface 109 of the first movable portion 110 may be planar or substantially flat. In other examples, the first surface 107 of the first movable portion 110 and/or the second surface 109 of the first movable portion 110 may include one or more curved portions or protrusions. It is noted that the shape, size, and materials used for the sections of the first compliant hinge 102 and the second compliant hinge 104 is highly dependent upon the type of device which incorporates one or more of the hinge systems 100.

Referring to the second compliant hinge 104 of FIG. 1, the second attachment portion 112 may include any of the features described with reference to the first attachment portion 106, the second flexible portion 114 may include any of the features described with reference to the first flexible portion 108, and the second movable portion 116 may include any of the features described with reference to the first movable portion 110. Because the second compliant hinge 104 may include any of the features described with reference to the first compliant hinge 102, the details of the second compliant hinge 104 are omitted for the sake of brevity. However, one or more dimensions (e.g., length, width, thickness, shape) of the second attachment portion 112, the second flexible portion 114, and/or the second movable portion 116 of the second compliant hinge 104 may be different than one or more dimensions (e.g., length, width, thickness) of the first attachment portion 106, the first flexible portion 108, and the first movable portion 110 of the first compliant hinge 102. In some examples, the first flexible portion 108 is not disposed across from the second flexible portion 114. For example, the first attachment portion 106 may be longer (or shorter) than the second attachment portion 112 in which the second flexible portion 114 is shifted with respect to the first flexible portion 108 along a length of the hinge system 100. In other examples, one or more sections of the second compliant hinge 104 may have one or more of the same dimensions of one or more sections of the first compliant hinge 102.

Referring to FIG. 3, the first attachment portion 106 of the first compliant hinge 102 and the second attachment portion 112 of the second compliant hinge 104 may define a combined section 124 in which the first attachment portion 106 is coupled to the second attachment portion 112. In some examples, the first attachment portion 106 is integrally formed with the second attachment portion 112. For example, the second compliant hinge 104 may be a continuation of the same layer of material that defines the first compliant hinge 102, but the layer of material is folded to create the first attachment portion 106 and the second attachment portion 112. In other examples, the first compliant hinge 102 is a separate layer of material than the second compliant hinge 104, and the first attachment portion 106 is coupled to the second attachment portion 112 using an adhesive or one or more fasteners.

The first attachment portion 106 may be fixedly disposed relative to the second attachment portion 112. In some examples, the first attachment portion 106 may be disposed parallel to the second attachment portion 112. In some examples, the first surface 103 of the first attachment portion 106 may be directly coupled to the first surface 111 of the second attachment portion 112. In some examples, the entire first surface 103 is coupled to the entire first surface 111. In other examples, only a portion of the first surface 103 is coupled to only a portion of the first surface 111. The hinge system 100 may define a central axis 118. For example, in the combined section 124, the central axis 118 extends through an intersection of the first attachment portion 106 and the second attachment portion 112. The central axis 118 may extend between the first attachment portion 106 and the second attachment portion 112.

Referring to FIGS. 1-3, the hinge system 100 may be configured to move from the un-deflected configuration in which the first movable portion 110 and the second movable portion 116 are proximate to each other (or contact each other) to the deflected state in which the first movable portion 110 and the second movable portion 116 are disposed part from each other. For example, in the un-deflected configuration, both the first compliant hinge 102 and the second compliant hinge 104 are in a linear configuration such that the first compliant hinge 102 is substantially parallel to the second compliant hinge 104. In the un-deflected configuration, a longitudinal axis 120 of the first movable portion 110 may be parallel to the central axis 118, and a longitudinal axis 122 of the second movable portion 116 may be parallel to the central axis 118. In some examples, the first surface 107 of the first movable portion 110 may contact a first surface 117 of the second movable portion 116. In other examples, in the un-deflected configuration, the first surface 107 may be parallel to the first surface 117, but the first surface 107 (or a portion thereof) may be disposed apart from the first surface 117.

When moving from the un-deflected configuration to the deflected configuration, the first flexible portion 108 of the first compliant hinge 102 may bend causing the first movable portion 110 to move or rotate away from the central axis 118 in a first direction D₁. Also, when moving from the un-deflected configuration to the deflected configuration, the second flexible portion 114 of the second compliant hinge 104 may bend causing the second movable portion 116 to move or rotate away from the central axis 118 in a second direction D₂. In some examples, the second direction D₂ is the opposite of the first direction D₁.

In the deflected configuration, the longitudinal axis 120 of the first movable portion 110 and the central axis 118 may form a first angle of deflection A₁. In some examples, the first angle of deflection A₁ is a maximum angle of deflection at which the first movable portion 110 can form with the central axis 118 in the first direction D₁. For example, the first movable portion 110 may be prevented from moving in the first direction D₁ beyond the first angle of deflection A₁. In this example, the first flexible portion 108 may be constructed such that the first flexible portion 108 is able to bend until reaching the first angle of deflection A₁. In some examples, the first angle of deflection A₁ is an acute angle. However, the first angle of deflection A₁ may be other types of angles such as a right angle or obtuse angle.

In the deflected configuration, the longitudinal axis 122 of the second movable portion 116 of the second compliant hinge 104 and the central axis 118 may form a second angle of deflection A₂. In some examples, the second angle of deflection A₂ is a maximum angle of deflection at which the second movable portion 116 can form with the central axis 118. For example, the second movable portion 116 may be prevented from moving in the second direction D₂ beyond the second angle of deflection A₂. In this example, the second flexible portion 114 may be constructed such that the second flexible portion 114 is able to bend until reaching the second angle of deflection A₂. In some examples, the second angle of deflection A₂ is an acute angle. However, the second angle of deflection A₂ may be other types of angles such as a right angle or obtuse angle. The second angle of deflection A₂ may be the same as the first angle of deflection A₁. In some examples, the second angle of deflection A₂ may be different than the first angle of deflection A₁. As shown in FIG. 3, the first compliant hinge 102 is coupled to the second compliant hinge 104 in a manner that combines each compliant hinge's angle of deflection (A₁, A₂), thereby providing a greater sweep angle (B₁) than what can be provided by a single compliant hinge having the same length.

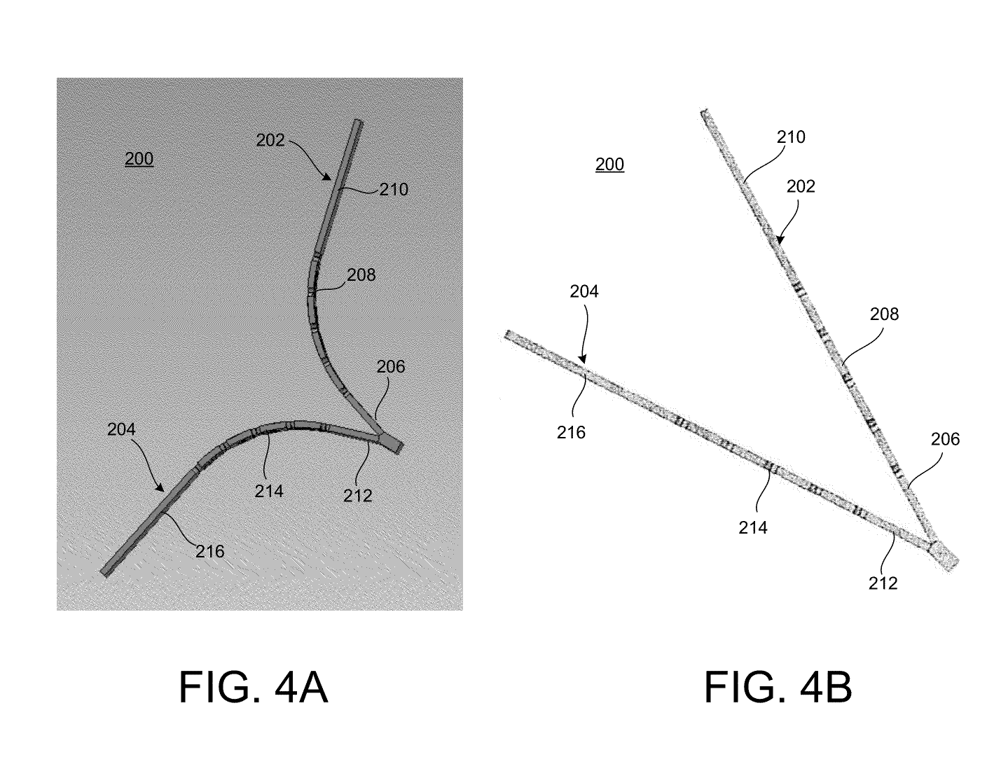

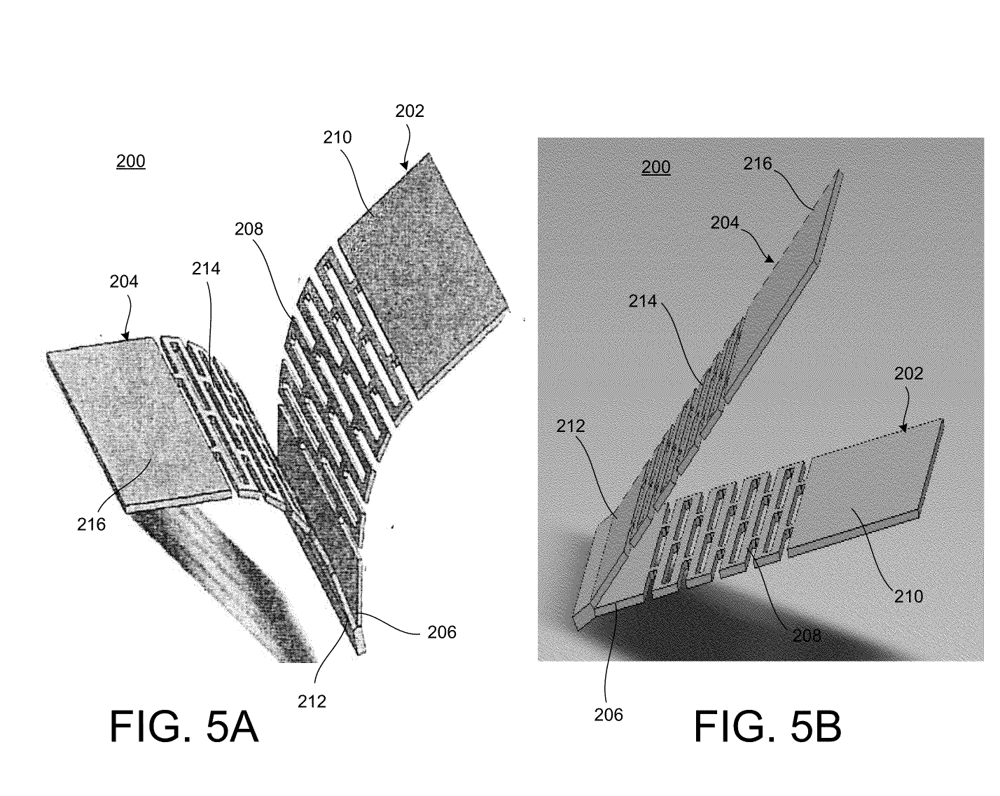

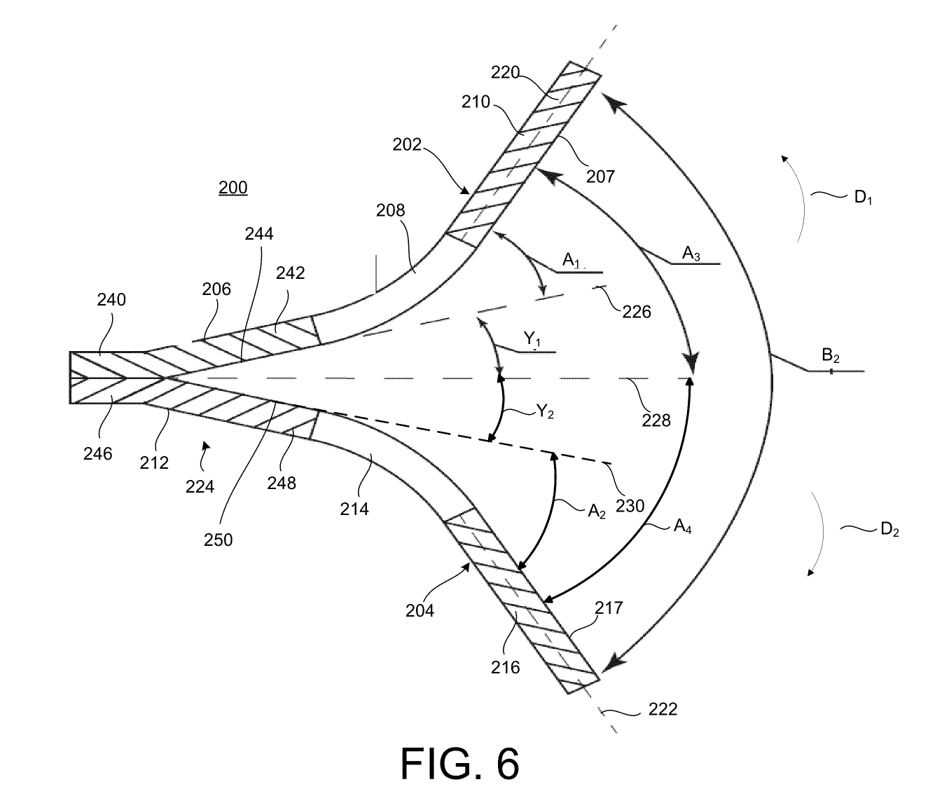

FIGS. 4-6 illustrate a hinge system 200 according to another aspect in which a first compliant hinge 202 is coupled to a second compliant hinge 204 at a non-zero angle. FIG. 4A illustrates a side view of the hinge system 200 in a deflected configuration according to an aspect. FIG. 4B illustrates a side view of the hinge system 200 in an un-deflected configuration according to an aspect. FIG. 5A illustrates a perspective of the hinge system 200 in the deflected configuration according to an aspect. FIG. 5B illustrates a perspective of the hinge system 200 in the un-deflected configuration according to an aspect. FIG. 6 illustrates a side view schematic of the hinge system 200 according to an aspect.

The hinge system 200 may be similar to the hinge system 100 of FIGS. 1-3 except that the first compliant hinge 202 is attached to the second compliant hinge 204 at a non-zero angle, whereas the first compliant hinge 102 is attached to the second compliant hinge 104 at a zero angle. The first compliant hinge 202 may include a first attachment portion 206, a first flexible portion 208, and a first movable portion 210, and the second compliant hinge 204 may include a second attachment portion 212, a second flexible portion 214, and a second movable portion 216. Since the components of the first compliant hinge 202 and the second compliant hinge 204 may include any of the features described with reference to the first compliant hinge 102 and the second compliant hinge 104, the details of these components will be omitted for the sake of brevity.

Referring to FIGS. 4-6, the first attachment portion 206 and the second attachment portion 212 may define a combined section 224 in which the first attachment portion 206 is coupled to the second attachment portion 212 at a non-zero angle. In some examples, the non-zero angle is an acute angle. As a result, in the un-deployed configuration, although the first compliant hinge 202 and the second compliant hinge 204 is in a linear configuration (e.g., the first flexible portion 208, and the second flexible portion 214 are not bent), the first compliant hinge 202 is disposed at a non-zero angle (e.g., acute angle) with the second compliant hinge 204. In contrast, with respect to FIGS. 1-3, in the un-deployed configuration, the first compliant hinge 102 is disposed in parallel with the second compliant hinge 104.

Referring to FIG. 6, the first attachment portion 206 of the first compliant hinge 202 may define a first coupling portion 240 and a first angled portion 242 defining an inner surface 244. The second attachment portion 212 of the second compliant hinge 204 may define a second coupling portion 246 and a second angled portion 248 defining an inner surface 250. The first coupling portion 240 may be coupled to the second coupling portion 246. The first angled portion 242 may extend from the first coupling portion 240 at a first angle Y₁. For instance, the inner surface 244 of the first angled portion 242 may define a first axis 226, and the first axis 226 may form the first angle Y₁ with a central axis 228 of the combined section 224. The central axis 228 may extend through an intersection of the first coupling portion 240 and the second coupling portion 246. The second angled portion 248 may extend from the second coupling portion at a second angle Y₂. For instance, the inner surface 250 of the second angled portion 248 may define a second axis 230, and the second axis 230 may form the second angle Y₂ with the central axis 228 of the combined section 224. In some examples, the first angle Y₁ is the same as the second angle Y₂. In other examples, the first angle Y₁ is different than the second angle Y₂. In the un-deflected configuration, the combination of the first angle Y₁ and the second angle Y₂ form the angle at which the first compliant hinge 202 is disposed from the second compliant hinge 204.

Referring to FIGS. 4-6, the hinge system 200 may be configured to move from the un-deflected configuration to the deflected configuration. In the un-deflected configuration, the first flexible portion 208 and the first movable portion 210 are linearly disposed with respect to each other and the second flexible portion 214 and the second movable portion 216 are linearly disposed with respect to each other such that the first movable portion 210 forms a non-zero angle (e.g., Y₁+Y₂) with the second movable portion 216.

When moving from the un-deflected configuration to the deflected configuration, the first flexible portion 208 of the first compliant hinge 202 may bend causing the first movable portion 210 to move or rotate away from the first axis 226 in a first direction D₁. Also, when moving from the un-deflected configuration to the deflected configuration, the second flexible portion 214 of the second compliant hinge 204 may bend causing the second movable portion 216 to move or rotate away from the second axis 230 in a second direction D₂. In some examples, the second direction D₂ is the opposite of the first direction D₁.

In the deflected configuration, an inner surface 207 of the first movable portion 210 and the first axis 226 of the first angled portion 242 may form a first angle of deflection A₁, and the central axis 228 and the inner surface 207 of the first movable portion 210 may form an angle A₃. In other examples, the first angle of deflection A₁ is defined by a longitudinal axis 220 of the first movable portion 210 and the first axis 226. In some examples, the first angle of deflection A₁ is a maximum angle of deflection at which the first movable portion 210 can form with the first axis 226 in the first direction D₁. For example, the first movable portion 210 may be prevented from moving in the first direction D₁ beyond the first angle of deflection A₁. In this example, the first flexible portion 208 may be constructed such that the first flexible portion 208 is able to bend until reaching the first angle of deflection A₁. In some examples, the first angle of deflection A₁ is an acute angle. However, the first angle of deflection A₁ may be other types of angles such as a right angle or obtuse angle.

In the deflected configuration, an inner surface 217 of the second movable portion 216 and the second axis 230 of the second angled portion 248 may form a second angle of deflection A₂, and the central axis 228 and the inner surface 217 of the second movable portion 216 may form an angle A₄. In other examples, the second angle of deflection A₂ may be defined by a longitudinal axis 222 of the second movable portion 216 and the second axis 230. In some examples, the second angle of deflection A₂ is a maximum angle of deflection at which the second movable portion 216 can form with the second axis 230 in the second direction D₂. For example, the second movable portion 216 may be prevented from moving in the second direction D₂ beyond the second angle of deflection A₂. In this example, the second flexible portion 214 may be constructed such that the second flexible portion 214 is able to bend until reaching the second angle of deflection A₂. In some examples, the second angle of deflection A₂ is an acute angle. However, the second angle of deflection A₂ may be other types of angles such as a right angle or obtuse angle. The second angle of deflection A₂ may be the same as the first angle of deflection A₁. In some examples, the second angle of deflection A₂ may be different than the first angle of deflection A₁. As shown in FIG. 6, the first compliant hinge 202 is coupled to the second compliant hinge 204 in a manner that combines each compliant hinge's angle of deflection (A₁, A₂), thereby providing a greater sweep angle (B₂) than what can be provided by a single compliant hinge having the same length.

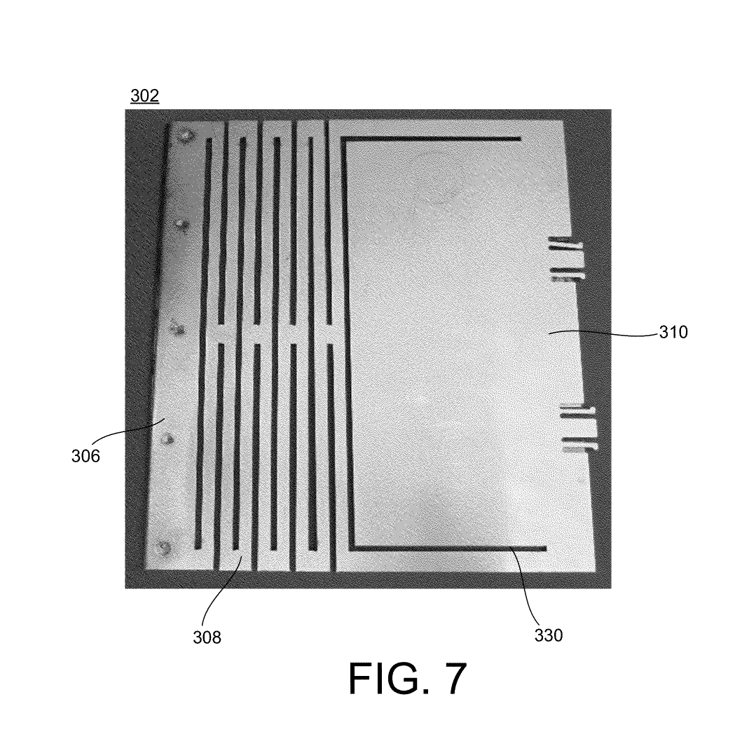

A wide variety of devices and systems may incorporate one or more of the hinge system 100 and/or the hinge system 200 in various manners. FIG. 7 illustrates an example of a compliant hinge 302 with a thermal expansion relief cut 330 according to an aspect. The compliant hinge 302 may be combined with another compliant hinge to create the hinge system 100 or the hinge system 200. The compliant hinge 302 may include any of the features described with reference to the first compliant hinge 102 or the second compliant hinge 204. For instance, the compliant hinge 302 may include an attachment portion 306, a flexible portion 308, and a movable portion 310. In some examples, the compliant hinge 302 may be used in applications that are exposed to a relatively high heat source. In some examples, the compliant hinge 302 may be a metal-based material such as stainless steel. When the compliant hinge 302 is exposed to relatively high heat, the flexible portion 308 may buckle due to uneven thermal expansion. However, the buckling may be prevented through the use of the thermal expansion relief cut 330.

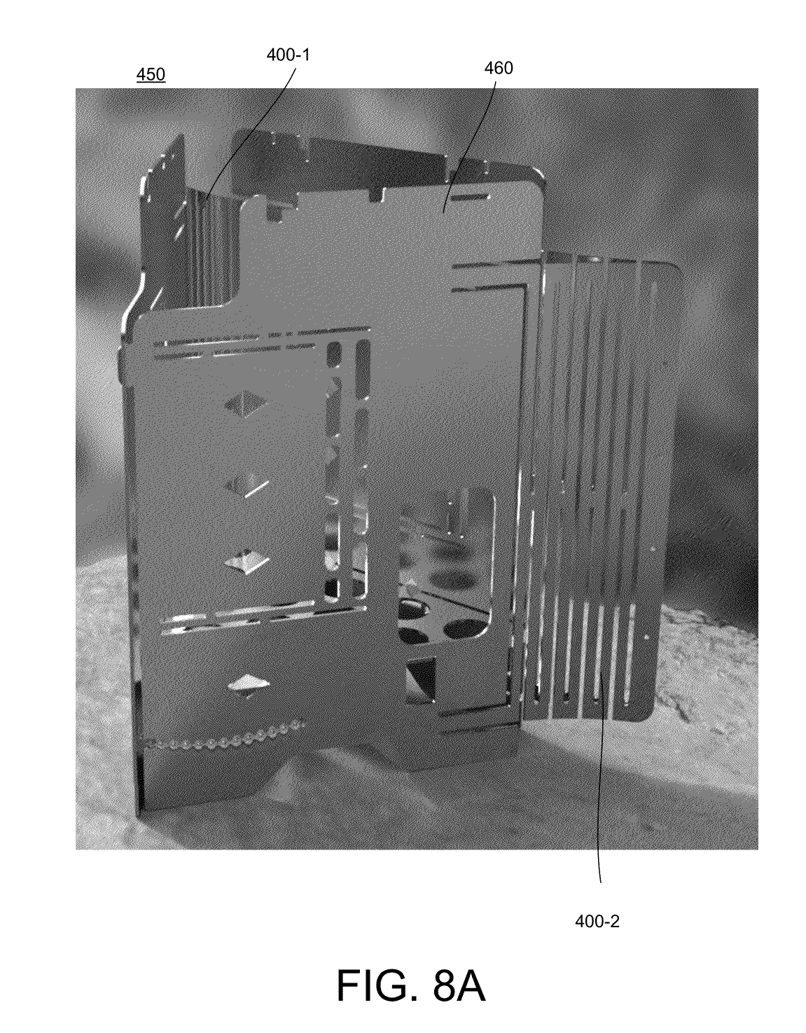

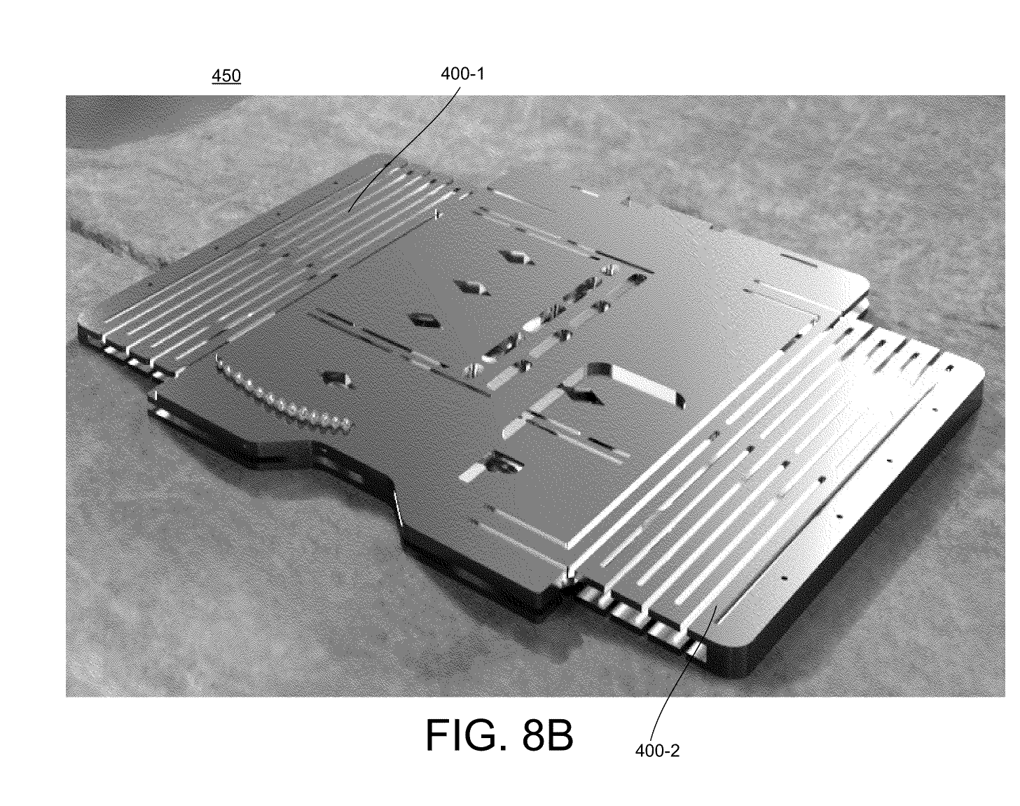

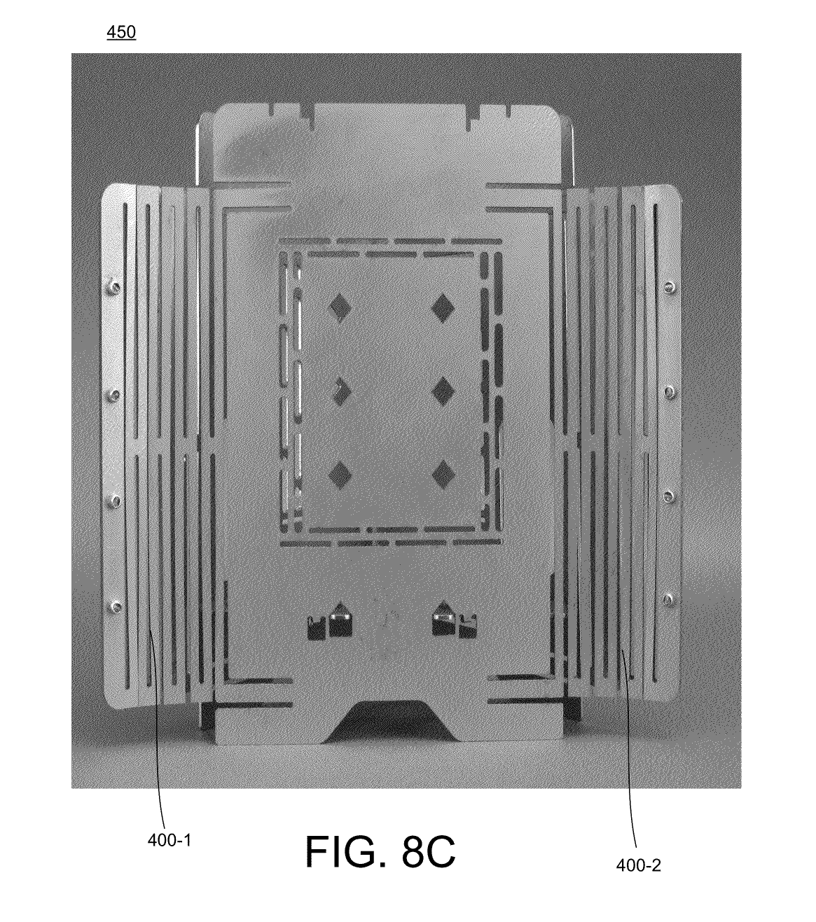

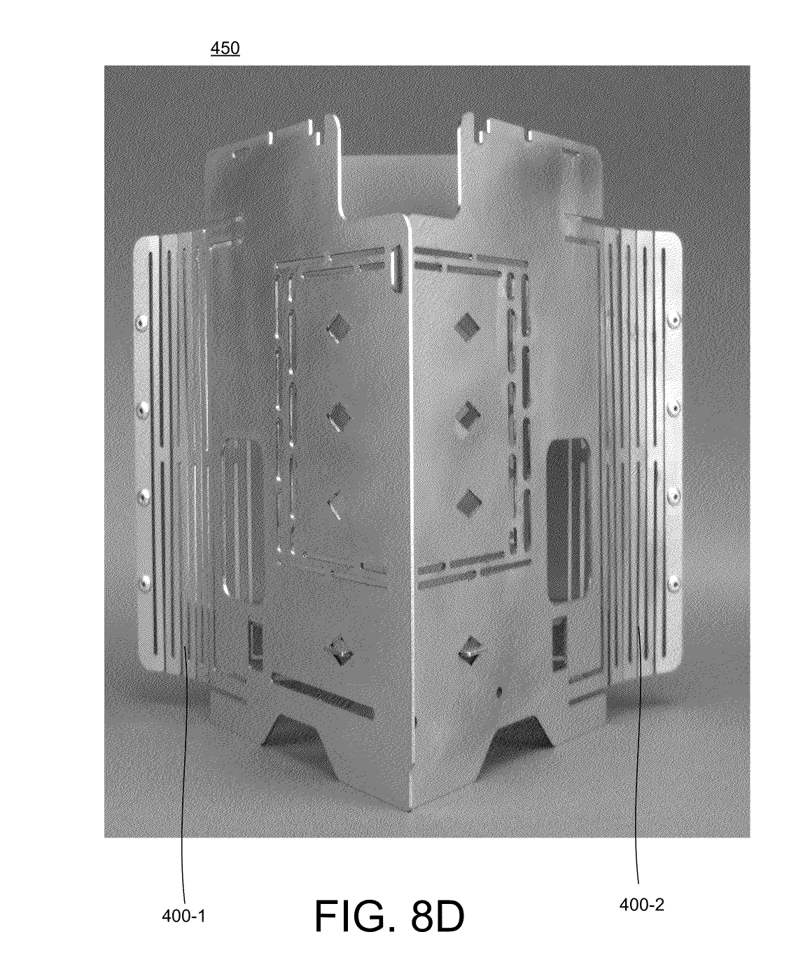

FIGS. 8A-8D illustrates an example of using two hinge systems (400-1, 400-2) within a camping stove assembly 450 that can be deployed by moving to the deflected configuration to create a triangular body 460, and stowed by moving to the un-deflected configuration such that the triangular body 460 collapses upon itself according to an aspect. FIG. 8A illustrates a deployed camping stove assembly 450 with panels connected by a first hinge system 400-1 and a second hinge system 400-2 to create the triangular body 460 of the camping stove assembly 450. Each of the first hinge system 400-1 and the second hinge system 400-2 may be the hinge system 100. FIG. 8B illustrates a stowed camping stove assembly 450 with the first hinge system 400-1 and the second hinge system 400-2 in the un-deflected configuration such that the camping stove assembly 450 is folded upon itself. FIG. 8C illustrate a perspective of the camping stove assembly 450 with the first hinge system 400-1 and the second hinge system 400-2 in the deployed configuration according to an aspect. FIG. 8D illustrate another perspective of the camping stove assembly 450 with the first hinge system 400-1 and the second hinge system 400-2 in the deployed configuration according to another aspect.

It is understood that the disclosed embodiments are merely examples, which may be embodied in various forms. Therefore, specific structural and functional details disclosed herein are not to be interpreted as limiting, but merely as a basis for the claims and as a representative basis for teaching one skilled in the art to variously employ the embodiments in virtually any appropriately detailed structure. Further, the terms and phrases used herein are not intended to be limiting, but to provide an understandable description of the embodiments.

It will also be understood that when an element, such as a layer, a region, or a substrate, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “moveably coupled,” as used herein, is defined as connected, although not necessarily directly and mechanically. Accordingly, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A hinge system comprising:
a first compliant hinge having a first attachment portion, a first flexible portion, and a first movable portion, the first flexible portion being disposed between the first attachment portion and the first movable portion; and
a second compliant hinge having a second attachment portion, a second flexible portion, and a second movable portion, the second flexible portion being disposed between the second attachment portion and the second movable portion,
the first attachment portion being coupled to the second attachment portion,
the hinge system configured to move from an un-deflected configuration to a deflected configuration in which the first movable portion and the second movable portion move away from each other.

2. The hinge system of claim 1, wherein, in the un-deflected configuration, the first flexible portion and the second flexible portion are in a linear configuration.

3. The hinge system of claim 1, wherein, in the un-deflected configuration, the first attachment portion is coupled to the second attachment portion such that the first compliant hinge is disposed in parallel with the second compliant hinge.

4. The hinge system of claim 1, wherein, in the un-deflected configuration, the first attachment portion is coupled to the second attachment portion such that the first compliant hinge is disposed at a non-zero angle with the second compliant hinge.

5. The hinge system of claim 4, wherein the non-zero angle is an acute angle.

6. The hinge system of claim 1, wherein the first attachment portion is integral to the second attachment portion.

7. The hinge system of claim 1, wherein, in the deflected configuration, the first flexible portion bends such that a longitudinal axis of the first movable portion forms a first angle of deflection with a central axis of the hinge system, and the second flexible bends such that a longitudinal axis of the second movable portion forms a second angle of deflection with the central axis.

8. The hinge system of claim 7, wherein the first angle of deflection is the same as the second angle of deflection.

9. The hinge system of claim 7, wherein the first angle of deflection and the second angle of deflection are acute angles.

10. The hinge system of claim 1, wherein the first flexible portion defines slots.

11. A hinge system comprising:
a first compliant hinge having a first attachment portion, a first flexible portion, and a first movable portion, the first flexible portion being disposed between the first attachment portion and the first movable portion; and
a second compliant hinge having a second attachment portion, a second flexible portion, and a second movable portion, the second flexible portion being disposed between the second attachment portion and the second movable portion,
the first attachment portion being coupled to the second attachment portion,
the hinge system configured to move from an un-deflected configuration to a deflected configuration such that the first movable portion and the second movable portion move away from each other, wherein, in the deflected configuration, the first flexible portion bends such that the first movable portion and the first attachment portion forms a first angle of deflection, and the second flexible portion bends such that the second movable portion and the second attachment portion forms a second angle of deflection,
wherein movement from the un-deflected configuration to the deflected configuration defines a sweep angle of the hinge system, the sweep angle being defined by a combination of the first angle of deflection and the second angle of deflection.

12. The hinge system of claim 11, wherein, in the un-deflected configuration, the first flexible portion and the second flexible portion are in a linear configuration.

13. The hinge system of claim 11, wherein, in the un-deflected configuration, the first attachment portion is coupled to the second attachment portion such that the first compliant hinge is disposed in parallel with the second compliant hinge.

14. The hinge system of claim 11, wherein, in the un-deflected configuration, the first attachment portion is coupled to the second attachment portion such that the first compliant hinge is disposed at a non-zero angle with the second compliant hinge.

15. The hinge system of claim 14, wherein the non-zero angle is an acute angle.

16. The hinge system of claim 11, wherein the first attachment portion is integral to the second attachment portion.

17. The hinge system of claim 11, wherein the first angle of deflection is the same as the second angle of deflection.

18. The hinge system of claim 11, wherein the first angle of deflection and the second angle of deflection are acute angles.

19. The hinge system of claim 11, wherein each of the first flexible portion and the second flexible portion defines slots.

20. A hinge system comprising:
a compliant hinge having an attachment portion, a flexible portion, and a movable portion, the flexible portion being disposed between the attachment portion and the movable portion; and
an elongate member having a first end portion and a second end portion,
the attachment portion of the compliant hinge being coupled to the first end portion of the elongate member, wherein the hinge system configured to move from an un-deflected configuration to a deflected configuration in which the movable portion of the complaint hinge and the second end portion of the elongate member move away from each other.
